(19) United States
(12) Patent Application Publication
(10) Pub. No.: US 2011/0149160 A1
(43) Pub. Date: Jun. 23, 2011

(54) SYSTEM AND METHOD FOR ACTIVELY MANAGING PLAY BACK OF DEMO CONTENT BY A DISPLAY DEVICE BASED ON CUSTOMER ACTIONS

(75) Inventors: Peter Shintani, San Diego, CA (US); Brant L. Candelore, San Diego, CA (US)

(73) Assignees: SONY CORPORATION, Tokyo (JP); SONY ELECTRONICS INC., Park Ridge, NJ (US)

(21) Appl. No.: 12/643,746

(22) Filed: Dec. 21, 2009

(51) Int. Cl. H04N 5/445; G06K 9/00

(52) U.S. Cl. 348/564; 348/563; 382/100; 348/E05.103

(57) ABSTRACT

An embodiment of the invention involves an apparatus, such as a television, that comprises a memory, an optical sensor and a processor. The optical sensor is configured to capture at least one image present in front of the apparatus. The processor is coupled to the optical sensor. The processor is configured to (i) analyze the at least one image and determine if the at least one image depicts a specific action, (ii) render a first type of content for a first time period in lieu of rendering a second type of content that is rendered by the processor at times when the specified action is not detected, and (iii) render the second type of content for a second period of time after the first period of time for rendering the first type of content has elapsed, potentially even if another the specified action is detected during the second period of time. Other embodiments are described and claimed.

### FIELD

The invention generally relates to the field of consumer electronics. More particularly, one and more embodiments of the invention relate to a display device and method for actively managing play back of demo content within a partially-assisted or non-assisted commercial environment using a sensor that detects certain activity by a customer.

### BACKGROUND

Over the last decade, the purchasing experience for televisions and other consumer electronics has changed dramatically. Previously, consumer electronic retailers provided “assisted” commercial environments in which store personnel were trained to explain differences between competing consumer electronic products. In the sale of televisions for example, store personnel were given access to remote controls associated with each type of television on display. By having access to the remote controls, the store personnel were able to place the consumer electronic products into a various modes of operation in order to explain certain features and better respond to certain inquiries raised by customers.

As an example, if a customer was interested in a particular consumer electronic product such as a flat panel television, certain store personnel had access to the remote control associated with that particular television on display. The store personnel could turn on the television, could explain the capabilities of the television to the customer, and could place the television into a demo mode in order to illustrate features of this television. In many cases, the information provided by the store personnel and/or the content displayed during demo mode sufficiently explained why a particular television was better than other televisions in the marketplace. As a result, the customer was provided more detailed information concerning prized features of the television, and thus, was better able to make an educated decision as to which television to purchase rather than simply purchasing the less expensive television.

Unfortunately, over the last decade, the purchasing environment has changed from an “assisted” commercial environment to a “non-assisted” commercial environment that are used by big-box retailers such as COSTCO®, SAM'S CLUB®, WALMART® and the like. In a “non-assisted” commercial environment, a big-box retailer typically places a number of consumer electronic products in the same general location where it is difficult for store personnel or the customer to access.

As an illustrative example, where the consumer electronic products are flat panel televisions, the flat panel televisions are arranged in a display to prevent the customer from having physical access to the front or side control panels of these televisions. More specifically, the flat panel televisions are elevated above and recessed away from the aisle walkway so that the customer can see the displays and bezels of the flat panel televisions, but he or she is discouraged from accessing their control panels. Also, placement of the televisions behind boxed televisions mitigates the likelihood of a customer accessing the control panel of a selected television.

For these big-box retailers, all of the televisions are tuned to an in-store channel that provides streaming advertising content. However, the advertising content is not designed to highlight features of any particular television in order to assist the customer in his or her purchasing decision. Rather, the advertising content is a series of ads, normally not in high-definition, to promote various television shows and encourage the purchase of other products or services provided by the big-box retailer. Third parties, such as device manufacturers for example, are permitted to purchase advertising space within the streaming content, but such advertisements are infrequently purchased because they are extremely expensive. As a result, in this non-assisted commercial environment, customers simply rely on picture clarity and tend to have difficulties in discerning the true capabilities of the televisions when viewing the displayed advertising content.

As an illustrated example, the streaming advertising content provided over the in-store channel may be slow-moving images provided over standard definition or high-definition programming with minimum resolution (e.g., 720p supports a resolution of 1280×720 and a frame rate of 24 hertz “Hz”). As a result, when viewing the in-store advertising content, customers will have difficulty in noticing major differences in picture clarity between the televisions on display, unlike the situation where the televisions are displaying high-resolution video of fast-paced sporting events, such as hockey or NASCAR for example. For this type of content, 1080p televisions that support higher resolution video, motion interpolation and/or higher refresh rates (e.g., rates ≧120 Hz) will provide superior picture quality over the lower priced 720p televisions that only support up to a 60 Hz refresh rate.

It would be advantageous to the customers to allow manufacturers to showcase features of their electronic devices through play back of a demo without substantially interrupting the streaming of the advertising content used as a revenue base by the big-box retailer. Additionally, it would be advantageous for the activation of the demo to be predicated on detected movements by the customer.

### BRIEF DESCRIPTION OF THE DRAWINGS

Embodiments of the invention may best be understood by referring to the following description and accompanying drawings that are used to illustrate embodiments of the invention.

FIG. 1 is an exemplary embodiment of one or more display devices displayed for sale in a non-assisted commercial environment.

FIG. 2 is an exemplary embodiment of an optical sensor implemented with a display device of FIG. 1.

FIG. 3A is an exemplary embodiment of a display device illustrated in FIG. 1 that supports an enhanced demo mode.

FIG. 3B is an embodiment of components implemented within the display device of FIG. 3A supporting the enhanced demo mode.

FIG. 4A is an illustrative embodiment of a screen display generated by a display device of FIG. 3A for placing the display device into a Retail operating mode.

FIG. 4B is an illustrative embodiment of a screen display generated by a display device of FIG. 3A for placing the display device into an operating mode that supports demos.

FIG. 4C is an illustrative embodiment of a screen display generated by a display device of FIG. 3A for selecting a particular demo supported by the display device.

FIG. 5 is a first exemplary embodiment of the operations conducted by the display device of FIG. 3A operating in the Enhanced Demo mode.

FIG. 6 is a second exemplary embodiment of the operations conducted by the display device of FIG. 3A operating in the Enhanced Demo mode.

### DETAILED DESCRIPTION

Herein, for the purposes of explanation, numerous specific details are set forth in order to provide a thorough understanding of the invention. It will be apparent; however, to one skilled in the art that the invention may be practiced without some of these specific details. In addition, the following description provides examples, and the accompanying drawings show various examples for the purposes of illustration. However, these examples should not be construed in a limiting sense as they are merely intended to provide examples of embodiments of the invention rather than to provide an exhaustive list of all possible implementations. Also, in some instances, well-known structures and devices are not shown in block diagram form in order to avoid obscuring the details of the disclosed features of various described embodiments.

In the following description, certain terminology is used to describe certain features of the invention. For instance, the term “communication link” is generally defined as an information-carrying medium that establishes a communication pathway. Examples of the medium include a physical medium (e.g., electrical wire, optical fiber, cable, bus traces, etc.) or a wireless medium (e.g., air in combination with wireless signaling technology). Also, the term “display device” is generally defined as an electronic device with display capabilities. Such display capabilities may range from an electronic device having an integrated display to an electronic device having no integrated display, but featuring one or more connectors that can be connected to route displayable content to an external display. For instance, examples of a display device include, but are not limited or restricted to a flat panel television (e.g., cathode ray tube “CRT”, liquid crystal display “LCD”, plasma, organic light-emitting diode “OLED”, or any television with another type of display technology), a computer, a video game console, a portable digital versatile disc (DVD) player, a handheld device (e.g., netbook, cellular phone, personal digital assistant “PDA,” etc.), or the like.

The term “logic” is generally defined as hardware and/or software configured to perform one or more functions. One example of a certain type of logic is a processor, a programmable circuit or an application specific integrated circuit (ASIC) that is designed to process signals for rendering content for display. The content may include graphics, images, images or video with or without audio. Another example of a certain type of logic is software, which is generally describes as a series of executable instructions in the form of an application, an applet, or even a routine. The software may be stored in any type of machine readable medium such as a programmable electronic circuit, a semiconductor memory device such as volatile memory (e.g., random access memory, etc.) and/or non-volatile memory such as any type of read-only memory (ROM) or flash memory, a portable storage medium (e.g., Universal Serial Bus “USB” drive, optical disc, digital tape), or the like.

The term “demo content” is displayable and/or auditory information that is intended for play back on a device (e.g., display device) in order to highlight the features of that device. In contrast, “advertising content” is displayable and/or auditory information for play back on a device, where the information is intended to advertise particular goods and/or services and does not pertain to the device itself.

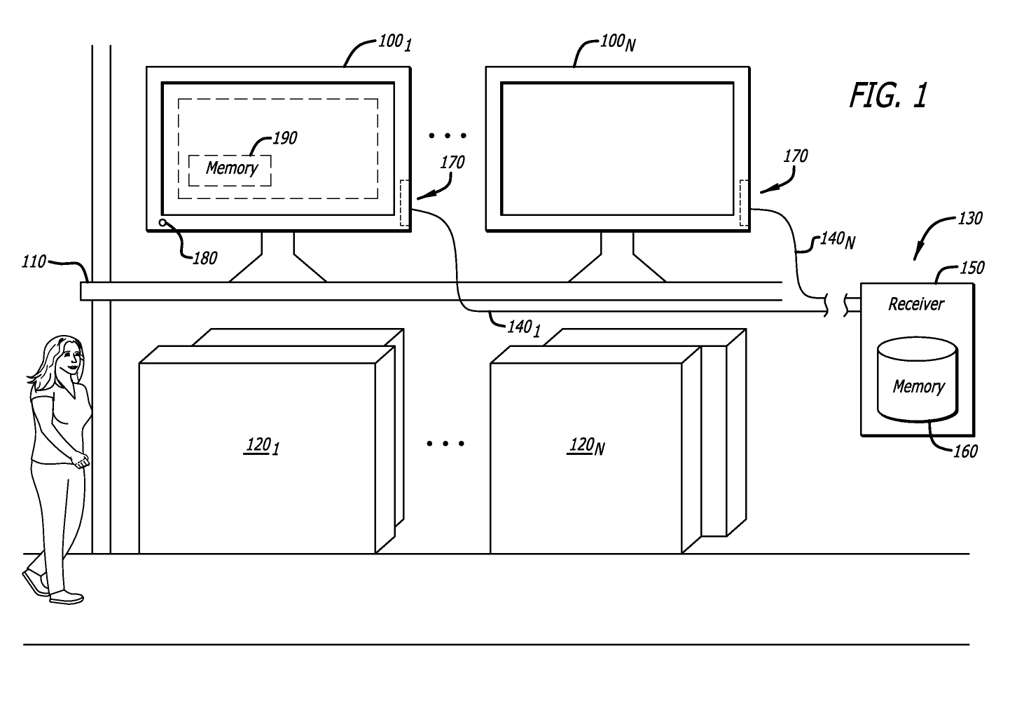

Referring to FIG. 1, an exemplary embodiment of multiple display devices residing in a non-assisted commercial environment is shown. According to this embodiment of the invention, display devices 100₁-100_{N} (N>2) are placed on a storage rack 110 in order to elevate these devices above an aisle walkway, and in some situations, are placed behind boxed versions 120₁-120_{N} of these display devices bordering the walkway. This environment, which promotes the separation of display devices 100₁-100_{N} from a customer and prevents the customer from altering the operating states of display devices 100₁-100_{N}, is referred to as a “non-assisted commercial environment,” namely a retail environment that does not encourage physical interaction with or testing of the display device by the customer before purchase.

Herein, all of display devices 100₁-100_{N} are in communication with a content forwarding system 130 via communication links 140₁-140_{N} and are tuned to receive the same in-store channel. According to one embodiment of the invention, content forwarding system 130 includes a receiver 150 that receives displayable content, such as advertising content, from a remote source (not shown). Receiver 150 may be configured to receive advertising content that is transmitted via satellite, optical or wired lines, wireless or the like. The advertising content is stored in memory 160 of receiver 150. The stored advertising content is subsequently streamed to each display device 100₁-100_{N}. The advertising content may be routed as YPbPr and baseband audio, although other analog or digital transmission schemes may be used. Of course, the advertising content may be transmitted via an HDMI port upon receipt and without prolonged or any storage within memory 160.

Besides receiving advertising content via a remote source, one or more display devices (e.g., at least display device 100₁) may be adapted to receive uploaded information, such as software, a demo configuration file or demo content, via a secondary communication port. For instance, display device 100₁ may include one or more connectors 170, being any type of input/output (I/O) connectors such as a USB connector onto which a USB drive may be coupled, in order to upload the demo content and a demo configuration file that lists the particular portions forming the demo content. The demo content may be displayed by display device 100₁ when operating in an Enhanced Demo mode and detection of a visual triggering event as described below.

According to at least one embodiment of the invention, a “visual triggering event” is an action conducted by a customer that is visually captured by an optical sensor 180 of display device 100₁ and determined by software residing within display 100₁ as being an action that prompts play back of demo content. For instance, if the triggering event involves the customer smiling at optical sensor 180, a facial image of the customer is captured and facial recognition software executed by logic within display device 100₁ analyzes a particular feature of the facial image, namely if the corners of the mouth are pointed upward to denote a smile.

More specifically, display device 100₁ may be configured to operate in one of two operational states: Home and Retail. For instance, when operating in the “Home” operational state, display device 100₁ may be configured to take greater advantage of power saving features, such as activating a presence sensor if implemented within display device 100₁ so that display device 100₁ is powered down if no movable objects are sensed in front of display device 100₁ for a prescribed period of time. More pertinent to the invention, however, display device 100₁ may be placed in the “Retail” operational state, which features two selectable modes; namely, Normal mode or Enhanced Demo mode. When placed in the Retail operational state, optical sensor 180 within display device 100₁ is activated. In general, optical sensor 180 converts a captured, optical image into an electric signal.

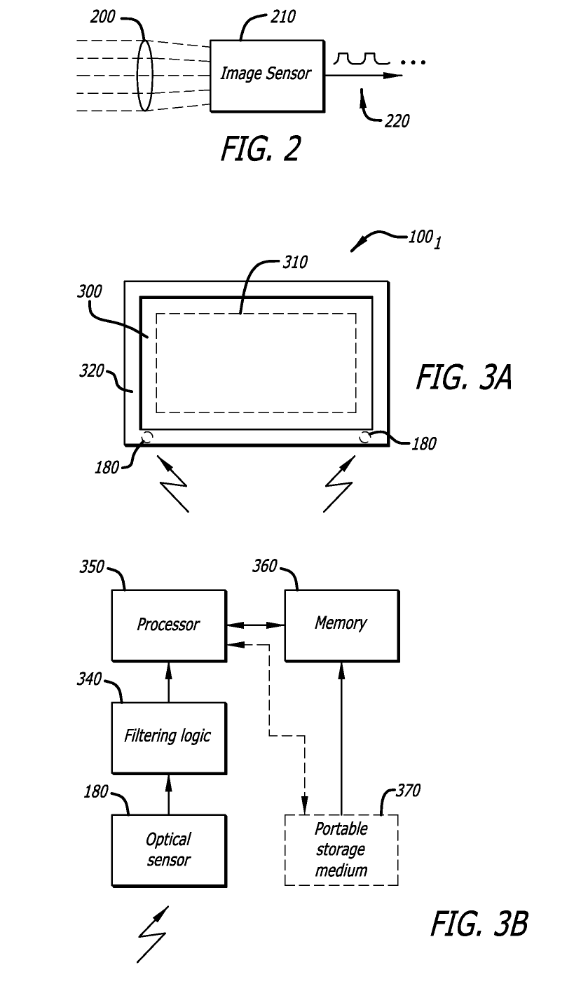

For instance, as shown in FIG. 2, optical sensor 180 may include a lens 200 and an image sensor 210 that receives light photons through lens 200. Image sensor 210 converts the captured light photons into electrical signals 220 that allow for image generation and specialized processing to recognize whether a visual triggering event has occurred. Examples of different image sensors include, but are not limited or restricted to a charge-coupled device (CCD) or a complementary metal-oxide-semiconductor (CMOS) active-pixel sensor. As an alternative to implementing optical sensor 180 within display device 100₁, it is contemplated that the presence may be re-tasked to operate as optical sensor 180 when display device 100₁ is placed into the Retail, Enhanced Demo mode. As yet another alternative, in lieu of these sensors, a digital camera separate from display device 100₁ may be coupled to connector(s) 170 in order to capture and route visual gestures to display device 100₁.

Referring back to FIG. 1, in Normal mode, display device 100₁ receives content from content forwarding system 130 and simply displays such content. However, in Enhanced Demo mode, display device 100₁ executes software, retrieved from internal memory 190 or from a portable storage medium coupled to USB connector 170, which causes display device 100₁ to monitor for one or more visual triggering events. Upon detecting a visual triggering event, display device 100₁ temporarily interrupts the display of the advertising content received by its HDMI or other communication port via communication link 140₁. During this interruption, the demo content has been either previously uploaded into internal memory 190 at manufacture/initialization or is currently stored in portable storage medium coupled to connector 170. This demo content is played back for display in order to highlight certain features of display device 100₁.

Referring to FIG. 3A, an exemplary embodiment of a display device 100₁ that supports an Enhanced Demo mode is shown. According to this embodiment of the invention, display device 100₁ is a flat panel television that features a screen 300, a rear casing 310 and a bezel 320. Rear casing 310 houses the backlight, processing circuitry and other logic that controls the operation of display device 100₁. Bezel 320 is situated to surround and partially overlay the perimeter of screen 300. According to one embodiment of the invention, one or more optical sensors 180 are sized so that a lens portion of each sensor (e.g., optical sensor 180) is not obscured by bezel 320. Multiple sensors may be used to capture images at different areas in front of display device 100₁. Of course, it is contemplated that these sensor(s) 180 may be coupled to an outer surface 330 of bezel 320.

Referring now to FIG. 3B, an exemplary embodiment of components implemented within display device 100₁ of FIG. 3A and utilized when display device 100₁ is placed in Enhanced Demo mode is shown. Herein, display device 100₁ comprises optical sensor 180, filtering logic 340, a processor 350 and memory 360. More specifically, when display device 100₁ is placed in Enhanced Demo mode, optical sensor 180 receives light photons forming an image in front of display device 100₁ and converts these light photons into voltages that can be converted on a pixel-by-pixel basis into image data. The image data is provided to filtering logic 340.

Filtering logic 340 is adapted to tailor the image data into a suitable format for processing by processor 350. For example, filtering logic 340 may include one or more correlation filters to minimize image distortion and enhance the digitized image as desired.

Processor 350 analyzes the image data to detect whether the captured image data constitutes a visual triggering event that will cause play back of the demo content. According to one embodiment of the invention, this analysis involves the execution of facial recognition software by processor 350 that uses specific facial features (e.g., nose, eyes, eye brows, chin, etc.) to focus on a location of the customer's face to determine if a visual triggering event has occurred (e.g., customer smiling for the optical sensor). If so, display device 100₁ executes logic to play back the demo content that is stored in memory 360. Memory 360 may constitute internal memory 190 of FIG. 1 or other memory. Alternatively, as represented by dashed lines, the executed logic may be stored within a portable storage medium 370 (e.g., USB drive) or processor may fetch the pre-stored audio clip from portable storage medium 370.

As an illustrative example, a smile by the customer may be selected as a visual triggering event. Periodically, when placed in Enhanced Demo mode, display device 100₁ may display a text message overlaying the streaming advertising content that invites a customer to smile to see demo content. During display of the text message, display device 100₁ captures the light photons in a direction from the customer, digitized the light photons into image data, and filters the image data for analysis by facial recognition software loaded in display device 100₁. Upon confirming that the consumer in front of display device 100₁ is smiling, display device 100₁ may immediately play back the demo content or may generate another text message overlaying the streaming advertising content requesting for the customer to smile again. The second text message and analysis of further captured image data simply is to ensure that a customer wants display device 100₁ to display the demo content, and the smiling conducted by the customer was not coincidental to the display of the first text message.

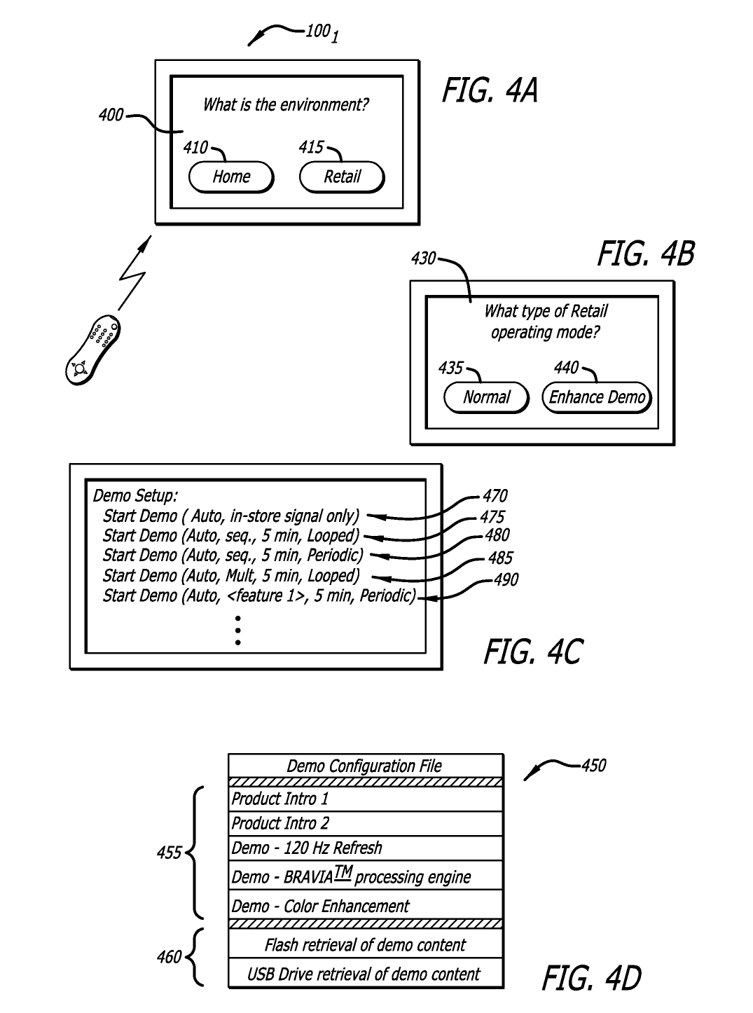

Referring to FIG. 4A, an illustrative embodiment of a screen display generated by display device 100₁ of FIG. 3A for placing display device 100₁ into the Retail operational state is shown. Herein, according to one embodiment of the invention, upon initial power-up, display device 100₁ displays an initialization screen display 400. Initialization screen display 400 allows the user to select a current operating state for display device 100₁ by selecting one of a plurality of option buttons 410 and 415. A first option button 410, if selected, places display device 100₁ into the Home operational state. A second option button 415, if selected, places display device 100₁ into the Retail operational state.

After selecting second option button 415 and placing display device 100₁ into the Retail operational state, a secondary screen display 430 is rendered as shown in FIG. 4B. Secondary screen display 430 illustrates what types of Retail operating modes are available and allows the user to select one of a plurality of option buttons 435 and 440 rendered on a screen of display device 100₁. A first option button 435 represents a Normal mode in which display device 100₁ operates to merely play back or display the advertising content received over one of its communication ports such as HDMI port, a YPbPr port and the like. A second option button 440 represents an Enhanced Demo mode, which causes execution of logic that is dedicated in supporting demo operations on display device 100₁.

More specifically, according to one embodiment of the invention, logic for supporting demo operations (hereinafter referred to as “demo-control logic”) is uploaded into internal memory (e.g., non-volatile memory such as flash or battery backed-up random access memory) within display device 100₁ during manufacture. In response to selecting second option button 440, the demo-control logic is retrieved and executed by the processor. Execution of the demo-control logic causes activation of the optical sensor to capture images, and thereafter, each captured image is digitized and filtered for use in verifying whether certain facial locations have a particular orientation. For instance, when the virtual triggering event is a smile, the demo-control logic analyzes whether the eyebrows are not sloped downward to show anger, corners of the mouth are pointing upward, and the like.

Upon detecting that the customer is smiling, display device 100₁ fetches the demo configuration file and the demo content from internal memory. Herein, the demo content is stored with corresponding control information that identifies the type of demo content uploaded. For instance, the control information may identify the demo content to be one of a number of content types, such as graphics (text), graphics (text) with audio, images, images and audio, or video for example. The control information is fetched along with the demo content and may be used by display device 100₁ to determine behavioral characteristics of display device 100₁.

Alternatively, the control information may be stored as part of the demo content. For instance, the demo content may be separated into definable segments (e.g., frames, cells, etc.) with each segment featuring a header portion that includes content type. The content type information is used by display device 100₁ to determine behavioral characteristics of display device 100₁.

FIG. 4C is an illustrative embodiment of a screen display generated by a display device of FIG. 3A for placing display device 100₁ into one of a plurality of Enhanced Demo modes is shown. Herein, display device 100₁ is placed in the Enhanced Demo mode and, upon placement of this mode, display device 100₁ accesses the demo configuration file to identify and subsequently display the number of demo options available to the retailer as provided by the demo configuration file. For instance, as shown in FIG. 4D, demo configuration file 450 may feature demo video clips 455 that are directed to explanation of display device 100₁ as a whole (Product Intro) or particular features of display device 100₁. Also, demo configuration file 450 may include fields 460 to direct display device 100₁ to fetch and display other demo content from internal memory therein or from the portable storage medium.

Referring back to FIG. 4C, upon accessing the demo configuration file, display device 100₁ displays a plurality of demo options available to the retailer. The retailer is able to select one or more of these demo options, and based on the selection, play back these demo video clip(s) in response to detection of a visual triggering event. The manner of such play back may be “periodic” or “looped”. A “periodic play back” means that a series of demo video clips (e.g., one or more demo video clips) are played back and followed by at least a predetermined amount of time for play back of the streaming advertising content. According to one embodiment, the amount of time for playback of the streaming advertising content may be static or adjusted by the retailer, normally from zero minutes (immediate looped playback) and multiple minutes. The play back duration of the demo video clips does not to exceed two minutes for each detected visual triggering event. A “looped play back” means that, in response to detecting a visual triggering event, one or more demo video clips may be displayed successively with play back of streaming advertising interspersed between the demo video clips.

For instance, upon selection of a first demo option 470, only the in-store advertising content is used by display device 100₁ for demo purposes. However, upon selection of a second demo option 475, the display device automatically plays back one or more demo video clips in a looped play back manner, namely each demo video clip is directed to a different feature and a predetermined interval (e.g., five minutes) is required between the display of each demo video clip. The “predetermined interval” is a mandatory time period in which demo content is precluded from being displayed and only in-store advertising content is allowed to be displayed even if visual triggering events are detected.

Third demo option 480 involves the display device automatically playing back a video clip in a periodic play back fashion, where a demo video clip is played back followed by a predetermined interval (e.g., five minutes) for display of the streaming advertising content. After the predetermined interval, if another visual triggering event is detected, display device 100₁ is permitted to play back the demo content which may involve the same or different demo video clips.

If selected, a fourth demo option 485 involves the display of multiple demo video clips forming the demo content in a looped play back fashion with a predetermined interval interposed between the multiple demo video clips. Each demo video clip being directed to a different feature for display device 100₁. In contrast with second demo option 480 that involves a serial display of demo video clips, it is noted that multiple demo video clips are shown in between each predetermined interval.

A fifth demo option 490 involves the display in a periodic play back fashion of a demo video clip that is directed to a single feature of display device 100₁ and at least the predetermined interval is required after each display of the demo video clip. For instance, the demo video clip may be directed to a particular feature such as the processing engine used by display device 100₁. Herein, upon detection of a visual triggering event, the demo video clip directed to the processing engine is played back, and thereafter, the predetermined interval is required. Thereafter, if another visual triggering event is detected, the demo video clip directed to the processing engine is played back again. During the predetermined interval, according to one embodiment of the invention, no graphics or audio advising viewers as how to activate play back of the demo content is provided.

It is contemplated that, where the demo content is stored in flash memory, repeated accesses to flash memory may cause the lifetime of the flash to be reduced, and hence, the lifetime of the television may be reduced as well. One possibility to mitigate this issue is to copy the demo content into random access memory (RAM) and to read the demo content from RAM instead of flash memory. On boot, where the display device is a television, it already copies television software from flash memory to RAM. The television would need to do this for the demo content as well.

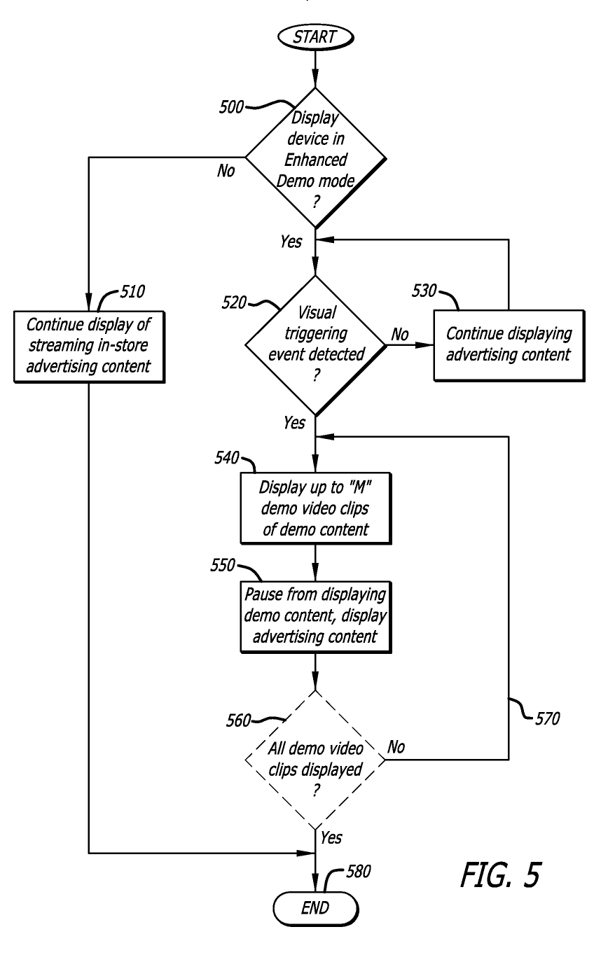

FIG. 5 is a first exemplary embodiment of the operations conducted by the display device of FIG. 3A operating in the Enhanced Demo mode. Initially, a determination is made whether the display device has been placed into Enhanced Demo mode (item 500). If not, the in-store advertising content is merely shown by the display device (item 510). However, if the display device has been placed into Enhanced Demo mode, a determination is made whether a visual triggering event has been detected (item 520).

If a visual triggering event is not detected, the display device simply continues to monitor for a visual triggering event (item 530). The streaming advertising content continues to be displayed at this time. However, if a visual triggering event is detected, the display device executes logic that causes demo content to be displayed in order to showcase attributes for the display device (item 540). The demo content may be “M” demo video clips (M>1), each corresponding to an attribute to be displayed before discontinuing the display of demo content and requiring in-store advertising content to be displayed for a predetermined interval. In other words, after displaying “M” demo video clip(s), a mandatory pause for the predetermined duration is conducted by the display device in order to ensure that the demo content is interspersed with the advertising content streamed into the display device (item 550). Thereafter, as an optional feature, a determination may be made as to whether demo video clips for all of the attributes associated with the selected demo content have been shown (item 560). If not, the display device continues to cycle through the remaining demo video clips forming the demo content (item 570). Otherwise, the operations conducted by the display device in response to a visual triggering event cease (item 580).

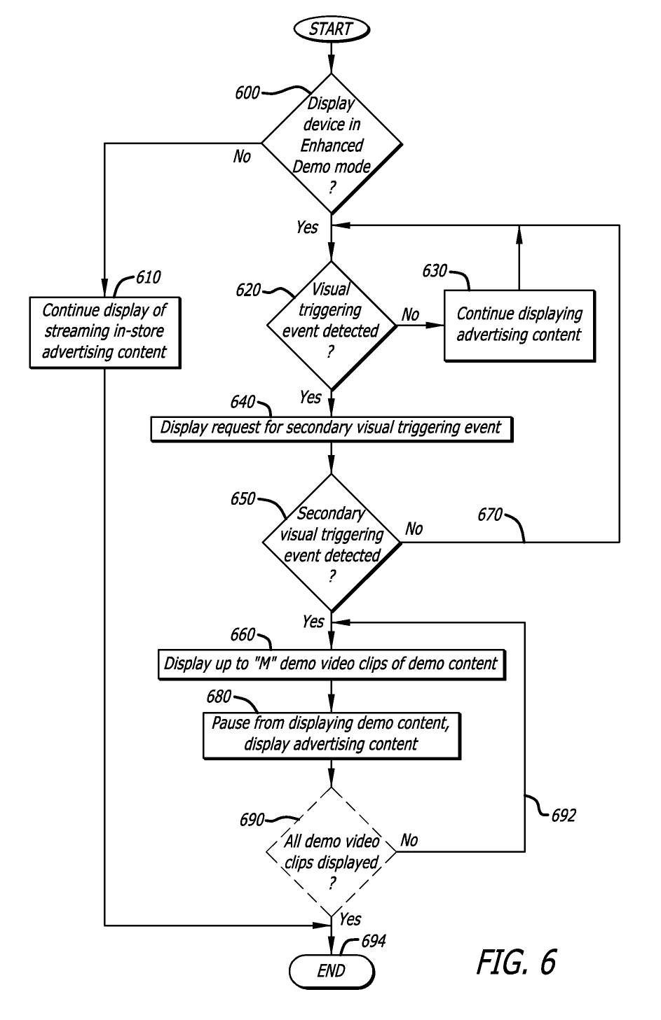

FIG. 6 is a second exemplary embodiment of the operations conducted by the display device of FIG. 3A operating in the Enhanced Demo mode. Initially, a determination is made whether the display device has been placed into Enhanced Demo mode (item 600). If not, the in-store advertising content is merely shown by the display device (item 610). However, if the display device has been placed into Enhanced Demo mode, a determination is made whether a visual triggering event has been detected (item 620).

If a visual triggering event is not detected, the display device simply continues to monitor for a visual triggering event and the streaming advertising content continues to be displayed (item 630). However, if a visual triggering event is detected, the display device executes logic that causes displayable information (e.g., a text message, an image, etc.) to be displayed to request the customer to perform a secondary visual triggering event in order to confirm that the customer requests a demo (item 640). The secondary visual triggering event may be the same or different from the initial visual triggering event.

If the secondary visual triggering event is detected prior to time-out, namely a time interval during which the display device monitors for the secondary visual triggering event, the demo content is displayed in order to showcase attributes for the display device (items 650 and 660). The demo content may be “M” demo video clips, which correspond to the number “M” of attributes to be displayed before requiring a predetermined interval for display of in-store advertising content. Otherwise, the display device returns to monitor for an initial visual triggering event (item 670).

After displaying these demo attributes, a mandatory pause for the predetermined invention is conducted by the display device in order to prevent cycling of the demo content and to ensure that the demo content is interspersed with the advertising content provided streamed into communication ports of the display device (item 680). Thereafter, as an optional feature, a determination may be made as to whether demo video clips for all of the attributes associated with the selected demo content have been shown (item 690). If not, the display device continues to cycle through the remaining demo video clips (item 692). Otherwise, the operations conducted by the display device in response to a visual triggering event cease (item 694).

Having disclosed exemplary embodiments and the best mode, modifications and variations may be made to the disclosed embodiments while remaining within the scope of the embodiments of the invention as defined by the following claims.

What is claimed is:

1. A method for automatically controlling a display device to display demo content intermittently between segments of streaming advertising content, the method comprising:
receiving advertising content;
displaying the advertising content by the display device;
monitoring for a first visual triggering event by an optical sensor of the display device, the first visual triggering event being at least one image visually captured by the optical sensor that prompts play back of the demo content;
automatically displaying the demo content for a first predetermined period of time, the first predetermined time period being less than fifteen minutes; and
continuing the display of the streaming advertising content by the display device.

2. The method of claim 1, wherein prior to monitoring for the first visual triggering event, the method further comprises:
displaying a text message over a portion of the advertising content, the text message requesting a viewer of the display device to perform a particular action.

3. The method of claim 2, wherein the monitoring of the first visual triggering event includes capturing the at least one image and analyzing the at least one image to determine if the image captures the viewer performing the particular action requested in the text message.

4. The method of claim 1, wherein the monitoring of the first visual triggering event includes capturing the at least one image on the optical sensor being an integrated component of the display device.

5. The method of claim 1, wherein the second predetermined period of time is greater in duration than the first predetermined period of time.

6. The method of claim 1, wherein prior to automatically displaying the demo content for the first predetermined period of time, the method further comprises:
repeating to monitor for a second visual triggering event, and upon detecting of the second visual triggering event, the demo content is automatically displayed.

7. The method of claim 1, wherein the display of the streaming advertising content by the display device occurs for a second predetermined period of time even if a second visual triggering event is detected during the second predetermined period of time.

8. The method of claim 1, wherein the second predetermined period of time is less than the first predetermined period of time.

9. A software stored within a memory and executed by a processor implemented within a display device being an electronic device with display capability, to perform the operations of:
displaying advertising content by the display device, the advertising content being routed from a first storage device that is remotely located from the display device;
monitoring for a first visual triggering event by an optical sensor of the display device, the first visual triggering event being at least one image visually captured by the optical sensor that signals the processor to play back demo content from a second storage device separate from the first storage device;
automatically displaying the demo content for a first predetermined period of time; and
continuing the display of the streaming advertising content by the display device for a second predetermined period of time even if a second visual triggering event is detected during the second predetermined period of time.

10. The software of claim 9, wherein during display of the advertising content and execution by the processor, performs an operation of displaying a text message over a portion of the advertising content, the text message requesting a viewer of the display device to perform a particular action.

11. The software of claim 10, wherein the monitoring for the first visual triggering event caused by execution of the software by the processor performs an operation of capturing the at least one image and analyzing the at least one image to determine if the at least one image captures the viewer performing the particular action requested in the text message.

12. The software of claim 9, wherein the monitoring of the first visual triggering event caused by execution of the software includes capturing of the at least one image on the optical sensor being an integrated component of the display device.

13. The software of claim 9, wherein the second predetermined period of time is greater in duration than the first predetermined period of time.

14. An apparatus comprising:
a memory;
an optical sensor to capture at least one image present in front of the apparatus;
a processor coupled to the optical sensor, the processor to (i) analyze the at least one image and determine if the at least one image depicts a specific action, (ii) render a first type of content for a first time period in lieu of rendering a second type of content that is rendered by the processor at times when the specified action is not detected, and (iii) render the second type of content for a second period of time after the first period of time for rendering the first type of content has elapsed regardless if another the specified action is detected during the second period of time.

15. The apparatus of claim 14, wherein the processor further renders the first type of content after the second period of time has elapsed and the specified action is again detected.
